(19) United States
(12) Patent Application Publication
(10) Pub. No.: US 2026/0073697 A1
(43) Pub. Date: Mar. 12, 2026

(54) CUSTOMIZED SYSTEM RESPONSE, VECTOR ENCODING, AND RELATED SYSTEMS, DEVICES, UNITS, AND METHODS

(71) Applicant: LiveView Technologies, LLC, American Fork, UT (US)

(72) Inventors: Michael N. Abbott, American Fork, UT (US); Eric N. Cheldelin, American Fork, UT (US); Caleb J. Hensley, American Fork, UT (US); Previn R. Menon, American Fork, UT (US); Steven R. Lindsey, American Fork, UT (US)

(21) Appl. No.: 19/326,633

(22) Filed: Sep. 11, 2025

Related U.S. Application Data
(60) Provisional application No. 63/693,890, filed on Sep. 12, 2024.
(60) Provisional application No. 63/760,303, filed on Feb. 19, 2025.

(51) Int. Cl. G06V 20/52; G06V 10/70; G06V 20/70; G06V 40/10; H04N 7/18

(52) U.S. Cl. CPC G06V 20/52; G06V 10/70; G06V 20/70; G06V 40/10; H04N 7/183; G06V 2201/08

(57) ABSTRACT

Various embodiments relate to systems for generating customized responses based on detected objects and/or object characteristics. A system may include a surveillance unit including at least one camera to capture at least one of image data or video data, an audio device including a speaker and to convey contents of an audio file, and at least one artificial intelligence (AI) model. The AI model may detect one or more objects in at least one of an image or a video captured by the camera; determine at least one characteristic of the at least one detected object of the one or more detected objects; and generate a description based on at least one of the at least one detected object or the at least one characteristic. The system may also include an additional AI model to generate the audio file based on the description. Associated systems and methods are also disclosed.

### PRIORITY CLAIM

This application claims the benefit of the filing date of U.S. Provisional Patent Application Ser. No. 63/693,890, filed Sep. 12, 2024, for “CUSTOMIZED SYSTEM RESPONSE, AND RELATED SYSTEMS, DEVICES, SURVEILLANCE UNITS, AND METHODS,” and of U.S. Provisional Patent Application Ser. No. 63/760,303, filed Feb. 19, 2025, for “REDUCING INFORMATION LOSS VIA VECTOR ENCODING, AND RELATED SYSTEMS, DEVICES, UNITS, AND METHODS,” the disclosures of each of which are hereby incorporated herein in their entirety by this reference.

### TECHNICAL FIELD

This disclosure relates generally to customized responses and, more specifically, to artificial intelligence-based responses by a surveillance system. The disclosure also relates to vector encoding for reducing information loss. Related systems, devices, units, and methods are also disclosed.

### BACKGROUND

Some security or surveillance systems may provide audio messages (e.g., warnings, alerts, announcements, etc.) or other outputs based on a predetermined schedule. Other security or surveillance systems, which may detect objects or other events, may generate event triggered pre-recorded audio outputs (e.g., audio messages). However, pre-recorded messages become stale and predictable and are not tailored based on an actual circumstance or an actual event. Therefore, over time, people do not believe that they are being monitored and thus these messages become ineffective to deter or encourage behavior. Further, live messages (e.g., warnings or announcements) require a live human (i.e., to monitor and provide a response) and thus live messages are untimely, expensive, and unrealistic for many applications.

### BRIEF SUMMARY

At least one embodiment of the disclosure includes a system including a mobile surveillance unit. The mobile surveillance unit may include at least one camera to capture at least one of image data or video data. Further, the mobile surveillance unit may include an audio device including a speaker and to convey contents of an audio file. The mobile surveillance unit may also include at least one artificial intelligence (AI) model to: detect one or more objects in at least one of an image or a video captured by the camera; determine at least one characteristic of the one or more detected objects; and generate a description based on at least one of the one or more detected objects or the at least one characteristic. The system may further include an additional AI model to generate the audio file based on the description.

Another embodiment includes a system including a surveillance unit. The surveillance unit may include at least one camera for capturing data, at least one speaker for conveying contents of an audio file, and at least one computer program. The at least one computer program may be configured to detect one or more objects in at least one of an image or a video of the data captured by the camera. The at least one computer program may also be configured to determine at least one characteristic of at least one detected object of the one or more detected objects. Further, the at least one computer program may be configured to generate a description based on at least one of the at least one detected object or the at least one characteristic. The system may also include a server remote from the surveillance unit and including at least one additional computer program to generate the audio file based on the description.

Another embodiment includes a method of operating a surveillance unit. The method may include capturing, via a camera of the surveillance unit, image data, video data, or both. The method may also include detecting, via at least one computer program, at least one object in at least one of an image of the image data or a video of the video data. Further, the method may include characterizing, via the at least one computer program, the at least one detected object. The method may further include generating, via the at least one computer program, a description of the at least one detected object based on the characterization of the at least one detected object. In addition, the method may include generating, via the at least one computer program, an audio file based on the description. Furthermore, the method may include conveying, via a speaker of the surveillance unit, a message of the audio file.

In yet another embodiment, a system includes a surveillance unit. The surveillance unit may include at least one sensor to capture sensor data and an output device to generate an output based on an audio file. The surveillance unit may further include at least one artificial intelligence (AI) model to detect one or more objects in the sensor data. In addition, the at least one AI model may determine at least one characteristic of at least one detected object of the one or more detected objects. The at least one AI model may generate a text description based on at least one of the at least one detected object or the at least one characteristic. Also, the at least one AI model may generate the audio file based on the description.

### BRIEF DESCRIPTION OF THE DRAWINGS

FIG. 1 depicts an example system including a unit, in accordance with various embodiments of the disclosure.

FIG. 2A depicts an example system including an input device, an output device, and a computer, in accordance with various embodiments of the disclosure.

FIG. 2B depicts another example system including a camera, a number of models, a message generator, and a speaker, according to various embodiments of the disclosure.

FIG. 3 is a block diagram depicting a system, according to various embodiments of the disclosure.

FIG. 4 depicts an example system including a number of models, according to various embodiments of the disclosure.

FIG. 5 depicts another example system including a unit and a remote device, in accordance with various embodiments of the disclosure.

FIG. 6 depicts another example system including a mobile unit, in accordance with various embodiments of the disclosure.

FIG. 7 depicts an example system including a number of mobile units, a server, and one or more devices, in accordance with various embodiments of the disclosure.

FIG. 8 illustrates another example system, according to one or more embodiments of the disclosure.

FIG. 9 is a flowchart illustrating an example method, according to various embodiments of the disclosure.

FIG. 10 is a flowchart illustrating another example method, according to various embodiments of the disclosure.

### DETAILED DESCRIPTION

Referring in general to the accompanying drawings, various embodiments of the present invention are illustrated to show example embodiments related to artificial intelligence (AI)-based responses by a unit, such as a surveillance unit (e.g., a mobile surveillance unit). Further, various embodiments of the present invention are illustrated to show example embodiments related to vector encoding on an edge device (e.g., to decrease information loss). It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to other systems and devices, such as stationary units (e.g., a unit coupled to a stationary pole (e.g., a light pole), a structure (e.g., of a business or a residence), a tree, etc.). Further, units and/or systems for indoor and/or outdoor use are within the scope of the disclosure. Embodiments of the disclosure will now be explained with reference to the accompanying drawings.

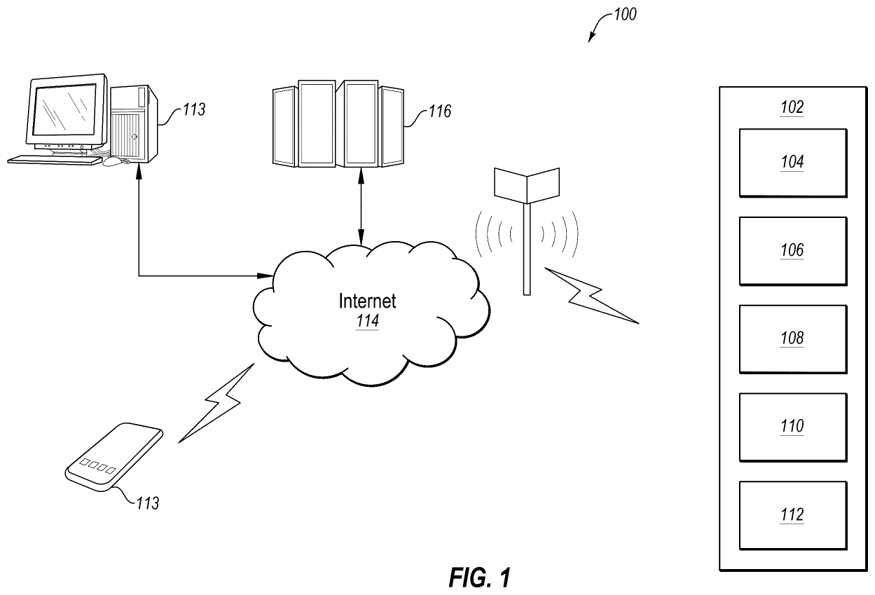

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors 104 (e.g., cameras, weather sensors, motion sensors, noise sensors, chemical sensors, without limitation) and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., loudspeakers, two-way public address (PA) speaker systems, or any other suitable speaker), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, RF sensors, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Computer 110 may include an operating system (e.g., installed on a hard drive). Moreover, although not shown in FIG. 1, unit 102 may include one or more additional devices including, but not limited to, one or more microphones, one or more solar panels, one or more power generators (e.g., fuel cell generators), or any combination thereof. Unit 102 may also include a communication device 112, which may comprise any suitable and known communication device (e.g., a modem (e.g., a cellular modem, a satellite modem, a Wi-Fi modem, etc.)). In some embodiments, communication device 112 may include one or more radios and/or one or more antennas. As will be appreciated, components of unit 102 may be suitably coupled via wired connections, wireless connections, or a combination thereof.

System 100 may further include one or more electronic devices 113, which may comprise, for example only, a mobile device (e.g., mobile phone, tablet, etc.), a laptop computer, a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114 (e.g., via one or more metered connections, such as cellular and/or a satellite connection).

According to various embodiments of the disclosure, unit 102 may be within a first location (a “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

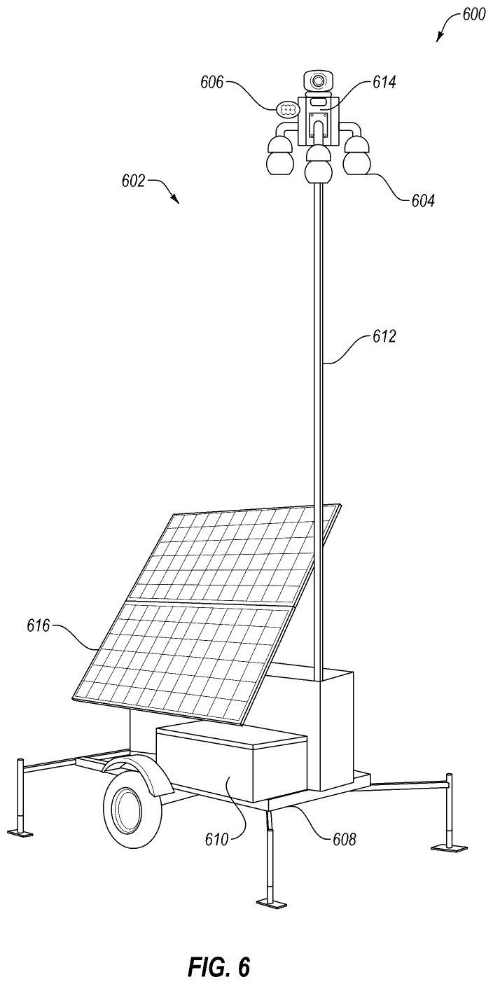

As noted above, in some embodiments, unit 102 may include a mobile unit (e.g., a mobile security/surveillance unit). In these and other embodiments, unit 102 may include a portable trailer (not shown in FIG. 1; see FIG. 6), a storage box (e.g., including one or more batteries) (not shown in FIG. 1; see FIG. 6), and a mast (not shown in FIG. 1; see FIG. 6) coupled to a head unit (e.g., including, for example, one or more cameras, one or more lights, one or more speakers, and/or one or more microphones) (not shown in FIG. 1; see FIG. 6). According to various examples, in addition to sensors and output devices, a head unit of unit 102 may include and/or be coupled to storage device 108, computer 110, and/or communication device 112.

According to various embodiments, a system may include at least one camera to capture image data (e.g., one or more images) and/or video data (e.g., one or more videos). Further, the system may include at least one computer program (e.g., one or more AI model(s) and/or other programs, models, and/or capabilities) to detect one or more objects in at least one of an image or a video captured by the camera. The at least one computer program may further determine at least one characteristic (also referred to herein as an “attribute”) of the one or more detected objects. Further, the at least one computer program may identify and/or generate information (e.g., description, such as a text description) based on the one or more detected objects and/or the at least one determined characteristic. Moreover, the at least one computer program may generate or identify an audio file (e.g., including a voice message) based on the one or more detected objects, the at least one determined characteristic, and/or the description. For example, a pre-recorded audio file (e.g., pre-recorded voice message) may be selected based on the one or more detected objects, the at least one determined characteristic, and/or the description (e.g., text description). In another example, an audio file (e.g., voice message) may be generated (e.g., dynamically generated) based on the one or more detected objects, the at least one determined characteristic, and/or the description (e.g., text description). The system may also include an audio device (e.g., including a speaker to convert an electrical signal into sound) to convey contents of the audio file (e.g., output the voice message via the speaker).

In contrast to conventional solutions, various embodiments may enable a customized response (e.g., a customized voice message) to be generated based on captured data (e.g., real-time data), and thus, compared to conventional solutions, various embodiments may provide a response (i.e., based on a real-time scenario) that increases the effectiveness of deterring unwanted behavior and/or encouraging desired behavior.

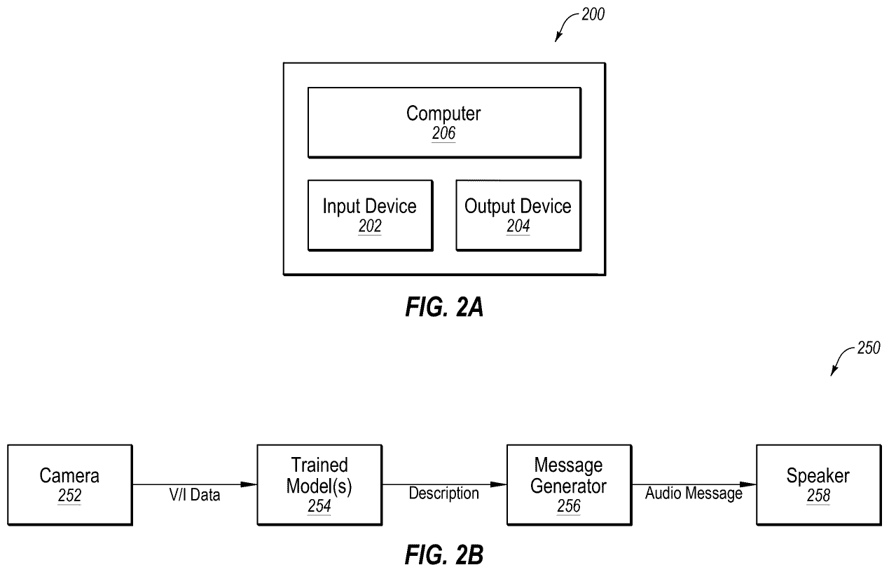

FIG. 2A is a simplified block diagram of a system 200, in accordance with various embodiments of the disclosure. System 200 includes at least one input device 202, at least one output device 204, and a computer 206. As non-limiting examples, input device 202 may include one or more cameras (i.e., for capturing image and/or video data) and/or sensors for capturing data, computer 206 may include and/or have access to one or models (e.g., artificial intelligence (A1) models), and output device 204 may include one or more speakers (e.g., for converting electrical signals into sound waves, allowing people to hear an audio voice message played via the speaker).

In various non-limiting examples, system 200 may include a surveillance system, which may include at least one surveillance unit (e.g., a mobile surveillance unit). In some non-limiting examples, a portion of computer 206 may be part of a surveillance unit (e.g., unit 102, such as a mobile surveillance unit), and another portion of computer 206 may be included in another device (e.g., server 116). More specifically, one or more AI models may exist (e.g., stored at) the surveillance unit and/or one or more AI models may exist (e.g., stored in) the server or another device.

In this embodiment, input device 202 may be configured to capture and send data (e.g., video data and/or image data) to computer 206, which may be configured receive the data and detect an object, a condition, and/or a scenario (e.g., human, vehicle, animal, weapon, fire, heat, crowd formation, actions, without limitation) (i.e., in the data) and possibly attribute data (also referred to herein as “characteristic data”) associated with the detected object. It is noted that “characteristic” and/or “attribute” may include, but is not limited to, what an individual is wearing, what the individual is doing (e.g., walking, dancing, sleeping, yelling, etc.), what the individual is holding (e.g., a cup, a bat, a knife, a gun, etc.), and/or where the individual is located (e.g., in a corner, by a garbage can, near a front door, on a sidewalk, next to a car, etc.).

Further, computer 206 may generate a customized output based on the detected object and possibly at least some of the attribute data. Moreover, output device 106 (e.g., including an audio device and/or a speaker) may convey the generated output (e.g., customized audio (e.g., voice) message). It is noted that although the disclosure references generating outputs based on image and/or video data, the disclosure is not so limited, and any sensor data (e.g., data from weather sensors, data from motion sensors, data from noise sensors, data from chemical sensors, without limitation) may be used to generate an output.

FIG. 2B is another illustration of a system 250, in accordance with various embodiments of the disclosure. System 250 includes at least one camera 252, a number of trained models (e.g., trained AI models) 254, a message generator 256, and at least one speaker 258. For example, input device 202 of FIG. 2A may include camera 252, computer 206 of FIG. 2A may include models 254 and message generator 256, and output device 204 of FIG. 2A may include speaker 258.

In the embodiment of FIG. 2B, camera 252 may be configured to capture data (e.g., image and/or video data) within a field of view thereof and provide at least some of the captured data to models 254. Models 254 may detect an object, an event, and/or a condition (e.g., human, vehicle, animal, weapon, fire, crown formation, humans fighting, human running, heat, ice, without limitation) in the captured data, sense attribute data (also referred to herein as “characteristic data”) (e.g., hair (e.g., color, length, etc.), clothing type and/or color, accessory type and/or color, without limitation) associated with the detected object, and generate a description (e.g., a text description) based on the detected object, event, condition, action, and/or any attribute data. Further, models 254 may generate a customized output (e.g., an audio file including an electrical audio signal) based on the description. Moreover, speaker 258 may convert a signal of the customized output to a sound, which may then be conveyed (e.g., customized audio (e.g., voice) message) via speaker 258.

For example, if an object detected is a human, characteristic data may include, for example only, data identifying a color and/or length of hair of the human (e.g., blonde hair, brown hair, etc.), a color of clothing worn by the human (e.g., blue shirt, yellow vest, black pants, etc.), an accessory type (e.g., hat, backpack, scarf, etc.) worn or carried by the human, a color of an accessory, without limitation. As another example, if an object detected is a vehicle, characteristic data may include a color of the vehicle, a type (e.g., sedan, truck, van, etc.) of the vehicle, a make and/or a model of the vehicle, a license plate number of the vehicle, a state (e.g., idling, parked, moving, etc.) of the vehicle, without limitation.

Characteristic data may further include, for example, data related to behavior of a detected object, such as that a human is running, a human is walking, a human is sitting, a human is standing, a human is falling or has fallen down, a human is lying down, a group of humans are gathering or have gathered, humans are fighting, without limitation. It is noted that detecting behavioral information may require that a detected object be tracked for at least some time duration. Further, tracking of objects may be performed by one or more models (e.g., AI models), as will be appreciated by a person of ordinary skill.

As noted above, an output (e.g., a voice message), which may be generated based on object, event, and/or condition data (i.e., what object(s) was detected) and/or characteristic data (i.e., characteristics of the detected object(s)), may be conveyed via speaker 258. As one example, a voice message including “attention individual wearing a blue hat, you are trespassing . . . the authorities have been notified” may be conveyed via speaker 258. As another example, a voice message including “attention individuals in the red vehicle, you are trespassing . . . please leave the area immediately” may be conveyed via speaker 258. As another example, a voice message including “attention person running through the parking lot, you are trespassing. Please leave the area immediately” may be conveyed via speaker 258. As yet another example, a voice message including “attention person on the construction site wearing a red shirt and without a hard hat, you are required to follow all safety protocols, please immediately comply with the hard hat requirement” may be conveyed via speaker 258. Along the same lines, if models 254 and/or computer 206 determines that a group of individuals (e.g., employees/contractors) is complying with safety protocols, a voice message including “attention individuals on the construction property, thank you for complying with all safety protocols” may be conveyed via speaker 258.

As noted above, a detected object may be tracked to assist in determining what behavior, if any, is occurring and possibly, for how long. In this example, a voice message including “attention individual with blonde hair and a black backpack, you have been loitering for 20 minutes. Please leave the area immediately” may be conveyed via speaker 258.

In some examples, object data may include additional detected objects, such as a weapon (e.g., firearm, knife, etc.) (e.g., being held by a detected human), fire, or other detectable object. Further, in some examples, attribute data may include additional behavioral data, such as a crowd forming (i.e., multiple humans detected within a certain area). In these examples, an audio message conveyed via speaker 258 may include a voice message, such as “attention individual holding a knife, the police have been notified and are en route.” As another example, a voice message conveyed via speaker 258 may include “attention individuals of a crowd forming in [Store X's] parking lot, you are being monitored.” As yet another example, a voice message including “attention, fire has been detected on the property, please leave the area immediately” or “ice has been detected on the property, please be cautious” may be conveyed via speaker 258. Other announcement examples include announcements addressing other attributes or behavior, such as fighting, lying down (e.g., sleeping), loitering, and others.

In some examples, if human identification is utilized, a customized response may indicate, or may be at least based on, whether or not the identified human has a prior history (i.e., has previously been detected at the location). For example, a voice message conveyed via speaker 258 may include “attention male in the green shirt, this is the second time this week that you have been loitering in this parking lot . . . the authorities have been notified.”

Although various embodiments are described with reference to safety, security, and/or surveillance applications, the disclosure is not so limited and other scenarios and/or applications may be within the scope of the disclosure. For example, operational in nature examples may be within the scope of the disclosure. As a more specific example, upon detecting (e.g., via one or more models) that a cart bay in a retail parking lot is becoming full of carts, a message (“shopping carts in the parking lot need to be collected and brought in”) may be generated and conveyed to store associates (e.g., via earpieces of store associates). As another example, upon detecting (e.g., via one or more models) that a customer is viewing an item (e.g., for at least a certain duration), a message (“a customer wearing a blue shirt in the lawn care department could use some assistance”) may be generated and conveyed to store associates (e.g., via earpieces of store associates).

It is noted that various settings associated with the generation and/or conveyance of a voice message may be selectable. For example, a desired tone (e.g., rate of speech, emphasis, pitch, intonation, etc.) of a message, a length of a message, a volume of a message, how many times the message is played, and/or other options may be selected to further customize the response. Also, other outputs (e.g., lights, sirens, etc.) may be utilized (e.g., before, during, and/or after conveying the voice message) to further enhance the response. For example, a spotlight may be shined on a detected object prior to, during, and/or after a voice message related to the object is conveyed.

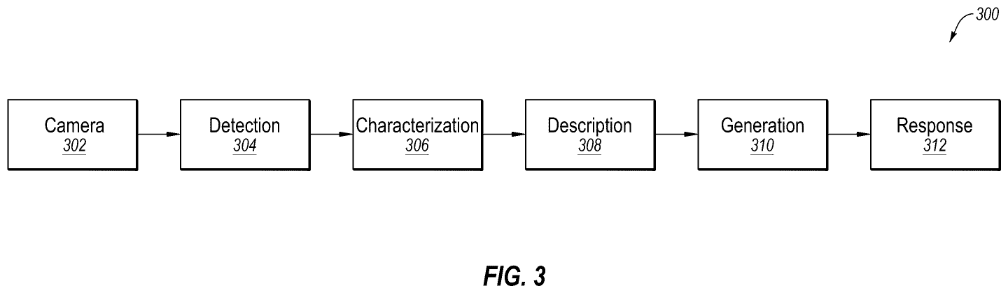

FIG. 3 is a block diagram depicting a system 300, according to various embodiments of the disclosure. For example, system 300 may be configured to generate an audio output based on sensed data (e.g., one or more objects and/or attributes of one or more objects). In some embodiments, at least a portion of system 300 may be part of a unit (e.g., a unit, such as a surveillance/security unit). Further, in some embodiments, a portion of system 300 may be part of another device (e.g., a cloud device (e.g., a server)).

In one example, system 300 includes an input device 302 (e.g., camera) for capturing data (e.g., images and/or video), a detection device 304 for detecting objects in an image and/or a video, a characterization device 306 for characterizing detected objects, and a description device 308 for describing characterized objects and/or characteristics (e.g., generating a description (e.g., a text description) of objects and/or associated characteristics, generating metadata regarding the image and/or the video, and/or any other info that is or describes what is included and/or seen in the image and/or video). Further, system 300 includes a generation device 310 for generating audio (e.g., an audio file) (e.g., based on a generated description) and an output device 312 for outputting (e.g., playing) the generated audio.

For example, detection device 304, which may include an artificial intelligence (AI) model, may receive data (e.g., one or more images and/or video files) (e.g., images and/or videos) and generate identity information related to any identified objects (e.g., human, car, animal, weapon, etc.) in the data. Further, characterization device 306, which may include an AI model, may receive the data and the identity information, and generate characteristic information regarding any identified objects. For example, the characteristic information may include one or more characteristics of one or more detected objects (e.g., human □ blue shirt; multiple humans □ forming a crowd; humans □ fighting; human □ not wearing a hard hat; human □ wearing a reflective safety vest; human □ trespassing; vehicle □ red sedan, arrived and parked in lot; vehicle □ white Ford truck, idling in parking lot; vehicle □ black van, speeding in parking lot; vehicle □ red Honda accord; human □ yellow shirt, loitering for X minutes; human □ has backpack, wearing a black hat, has a weapon; human □ red shirt, lying down).

A description device 308, which may include an AI model, may receive the data, the identify information, and/or the characteristic information, and generate a description (e.g., based on the data, the identify information, and/or the characteristic information). For example, description device 308 may generate the following text: “person in blue shirt and wearing a backpack is trespassing.” Further, the description (e.g., text description) generated via description device 308 may be provided to a generation device 310. In some embodiments, in addition to, or rather than, sending a text description, description device 308 may send the image and/or video to generation device 310, send metadata (e.g., that convey similar concepts to a plaintext description) to generation device 310, and/or send any other information about what is included and/or seen in the image and/or video to generation device 310.

Generation device 310 may receive the description and generate an audio message (e.g., a voice message) based on the description. For example, generation device 310, which may include a text-to-speech program (e.g., an AI model), may receive a text description and generate an audio message (e.g., a voice message) based on the text description. An output device 312, which may include, for example, a speaker, headset, radio, PA system, and/or any other audio device, may receive the audio file and output the audio file.

As will be appreciated by a person having ordinary skill, the AI models described herein may include any known and suitable models. As non-limiting examples, known models including, but not limited to, Llama 3.1; BLIP: Bootstrapping Language-Image Pre-training for Unified Vision-Language Understanding and Generation; Piper (text to speech); DETR (End-to-End Object Detection); and/or BLIP: Bootstrapping Language-Image Pre-training for Unified Vision-Language Understanding and Generation, may be used to carry out various embodiments disclosed herein.

In one non-limiting example, a surveillance unit (e.g., a mobile surveillance unit) (e.g., including an edge device) may include camera 302, detection device 304, characterization device 306, description device 308, and output device 312. In this example, generation device 310 may reside on another device, such as a remote cloud device (e.g., a cloud server). More specifically, for example, computer 110 of FIG. 1 may include detection device 304, characterization device 306, and description device 308, and server 116 (see FIG. 1) may include generation device 310.

In other examples, a surveillance unit may include each of camera 302, detection device 304, characterization device 306, description device 308, generation device 310, and output device 312. In other words, in this example, a surveillance unit (e.g., a mobile surveillance unit) may include each component of system 300. In this example, it may not be necessary for data to be conveyed to another device, such as a cloud server. In yet other examples, a surveillance unit may include camera 302 and output device 312, and detection device 304, characterization device 306, description device 308, and generation device 310 may be part of another device (e.g., reside in the cloud). In some examples, at least a portion of output device 312 may be separate from the surveillance unit. More specifically, for example, at least a portion of output device 312 may be or may be part of a PA system, a headset, earpiece, radio, and/or any combination thereof, without limitation. These configurations are provided as examples only and a person having ordinary skill in the art would understand that system 300 may be configured in a number of different configurations.

Some embodiments of the disclosure relate to vector encoding on an edge device (e.g., to decrease information loss). As will be appreciated, conventional systems and methods for transmitting information about events and/or data from an edge device (e.g., computer 110 of FIG. 1) to a remote device (e.g., server 116 of FIG. 1) include either transmitting a human readable description of the event or transmitting an entirety of media associated with the event (e.g., transmitting video and/or images of the event). Transmitting enumerated or text descriptions may lead to information loss. Further, transmitting media associated with an (e.g., an entire video stream) may consume substantial amounts of bandwidth and/or may be expensive due to substantial amounts of data being transmitted (e.g., over a metered (e.g., cellular or satellite) connection).

According to various embodiments of the disclosure, rather than generating a text description of a captured image, or structured metadata about specific items/objects in the captured image, data (e.g., captured video and/or image) may be tokenized into a vector space (e.g., via an encoder), which may be understood by an encoder (e.g., on an edge device) and/or decoder model (e.g., on a server), such as an LLM, allowing for a better information density and more accurate encoding than is possible with text alone.

Multi modal transformer models may leverage an encoding model that converts images, videos, or other data into a vector space that is shared across modalities. This may allow a model to “understand” input in multiple formats. According to various embodiments, a first device, such as a mobile unit (e.g., including an edge device) may include an encoding model, and a second device (e.g., a server, such as a cloud server) may include a larger generative transformer model. These models may allow the first device and the second device to communicate in a “language” that is understood. Vectorized encoding may be less lossy than converting to text and may consume less bandwidth for transmission compared to transmission of original media (e.g., video) (i.e., including a detected event and/or object).

According to various embodiments, in one example scenario, a unit (e.g., a mobile unit) may capture data (e.g., video data and/or image data) and detection of an event may occur. The captured data may be provided to an encoder model of the unit, and the encoder model may generate one or more vectors that are in a shared vector space with another (e.g., large generative transformer) model, which may exist in a cloud device (e.g., cloud server). The vector data may be transmitted from the unit to the cloud device, where the generative transformer model may generate some output, such as, for example only, a text snippet (or audio), which may be transmitted (e.g., from the cloud device) to and conveyed via the unit (e.g., played via a speaker of the unit (e.g., a surveillance unit)).

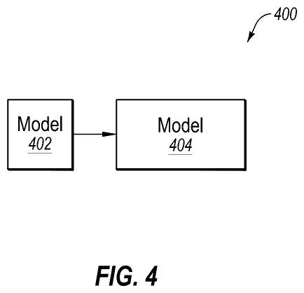

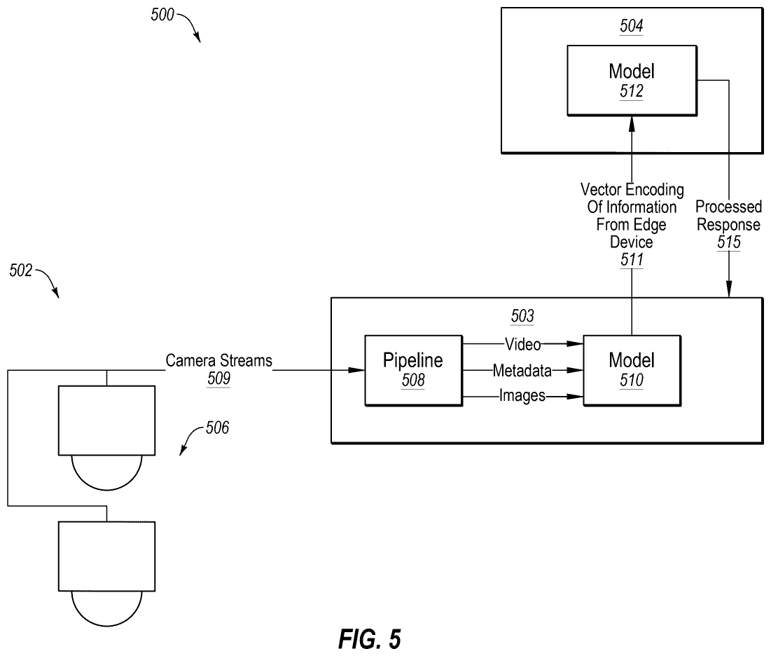

FIG. 4 depicts an example system 400, in accordance with various embodiments of the disclosure. System 400 includes a model 402 communicatively coupled to a model 404. Model 402 may include, for example, an encoder model, and model 404 may include, for example, a large language model (LLM). As described below with reference to FIG. 5, system 400 may be implemented with a security and/or surveillance application. However, it is noted that the disclosure is not so limited, and system 400 may be applied in other applications.

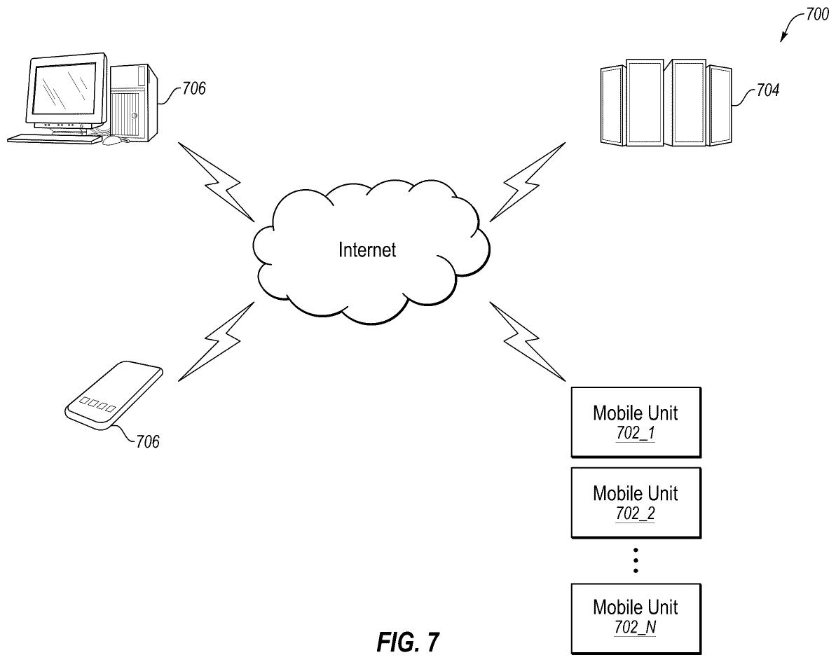

FIG. 5 depicts another system 500, according to various embodiments of the disclosure. System 500, which may be and/or include system 400 of FIG. 4, includes a unit 502 (e.g., a mobile unit, such as unit 102 (see FIG. 1), unit 602 (see FIG. 6), and/or mobile unit 702 (see FIG. 7)) including a device 503. System 500 further includes a device 504 (e.g., a remote device, such as a cloud device (e.g., a cloud server (e.g., server 116 of FIG. 1 and/or server 704 of FIG. 7)) communicatively coupled to device 503.

Device 503 (also referred to herein as “edge” or “edge device”) may include and/or be coupled to one or more cameras 506 of unit 502. Further, device 503 includes a pipeline (e.g., an analytics pipeline) 508 configured to receive input data 509 (e.g., one or more camera streams) from camera(s) 506 and generate output data (e.g., video data, metadata, and/or image data), which may be conveyed to a model 510. Model 510 may include, for example only, an encoder model. For example, the data output from pipeline 508 may include objects (e.g., one or more objects in video data, one or more objects in image data, and/or metadata associated with one or more objects). Model 510 may generate a vector encoding based on one or more objects in or associated with the data received at model 510. One or more vector encodings 511 and/or other associated data generated via encoder model 510 may be conveyed to device 504.

Device 504 (also referred to herein as “cloud device,” “cloud server,” or “server”) may include a model (e.g., an LLM) 512 that may receive one or more vector encodings generated via model 510. In some embodiments, model 512 may be trained via a visual instruction tuning process, as will be appreciated by a person having ordinary skill. Further, in some embodiments, model 510 and model 512 may be trained together (or in the same manner), and thus, in at least some embodiments, model 510 and model 512 may operate within the same vector space.

Model 512 may process one or more vector encodings (e.g., received from device 503) and generate a processed response 515, which may be provided to unit 502. For example, processed response 515, generated via model 512 and conveyed to device 503, may include text and possible other data, such as audio data. Further, in response to receipt of response 515 (also referred to herein as “response data,” “output data,” or some variation thereof), device 503 may generate and/or convey an output (e.g., based on response 515) (e.g., via a speaker). For example, unit 502 may include an output device (e.g., output device 312 of FIG. 3) for conveying response 515.

In some embodiments, model 512 may include a generative model, which may run in the cloud, and may be, for example, too large to run on the edge. As a non-limiting example, model 510 may include significantly less parameters than model 512. More specifically, for example only, model 510 may include approximately 300 million parameters and model 512 may include, for example, 400 billion parameters (e.g., requiring approximately 800 GB or more of memory). As will be appreciated, vector encoding is more space efficient than a full video or image, and vector encoding may be less lossy than human readable text describing a scene.

FIG. 6 depicts another example system 600 including a unit 602, in accordance with various embodiments of the disclosure. Unit 602, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 602 may include one or more sensors 604 (e.g., cameras, weather sensors, motion sensors, noise sensors, without limitation) and one or more output devices 606 (e.g., lights, speakers, electronic displays, without limitation). For example, sensors 604 may include sensors 104 of FIG. 1, input device 202 of FIG. 2, camera 302 of FIG. 3, cameras 506 of FIG. 5, and/or other input devices and/or sensors, and output device 606 may include output device 106 of FIG. 1, output device 204 of FIG. 2, and/or other output devices.

Unit 602 may also include at least one storage device (e.g., internal flash media, a network attached storage device, or any other suitable electronic storage device), which may be configured for receiving and storing data (e.g., video, images, audio, without limitation) captured by one or more sensors of unit 602. According to some embodiments, unit 602 may include unit 102 of FIG. 1, unit 502 of FIG. 5, and/or a mobile unit 702 of FIG. 7.

In some embodiments, unit 602 may include a mobile unit. In these and other embodiments, unit 602 may include a portable trailer 608, a storage box 610, and a mast 612 coupled to a head unit (also referred to herein as a “live unit,” an “edge device,” or simply an “edge”) 614, which may include (or be coupled to) for example, one or more batteries, one or more cameras, one or more lights, one or more speakers, one or more microphones, and/or other input and/or output devices. According to some embodiments, a first end of mast 612 may be proximate storage box 610 and a second, opposite end of mast 612 may be proximate, and possibly adjacent, head unit 614. More specifically, in some embodiments, head unit 614 may be coupled to mast 612 an end opposite an end of mast 612 proximate storage box 610.

In some examples, unit 602 may include one or more primary batteries (e.g., within storage box 610) and one or more secondary batteries (e.g., within head unit 614). In these embodiments, a primary battery positioned in storage box 610 may be coupled to a load and/or a secondary battery positioned within head unit 614 via, for example, a cord reel.

In some embodiments, unit 602 may also include one or more solar panels 616, which may provide power to one or more batteries of unit 602. More specifically, according to some embodiments, one or more solar panels 616 may provide power to a primary battery within storage box 610. Although not illustrated in FIG. 6, unit 602 may include one or more other power sources, such as one or more generators (e.g., fuel cell generators) (e.g., in addition to or instead of solar panels). Further, for example, unit 602 may be configured to couple to and receive power from an electrical outlet (e.g., an electrical wall socket). As will be appreciated, unit 602 may include one or controllers (e.g., within head unit 614) including one or more operating systems, which may be configured and/or updated in accordance with various embodiments disclosed herein.

FIG. 7 depicts a system 700, in accordance with various embodiments of the disclosure. System 700 includes a number of mobile units 702 (e.g., 702_1-702_N), a server 704, and one or more electronic devices 706. In one non-limiting example, mobile unit 702 may include, for example only, unit 102 (see FIG. 1), unit 502 (FIG. 5), unit 602 (FIG. 6), and/or another device. Server 704 may include a cloud server (e.g., server 116 (FIG. 1) and/or device 504 (FIG. 5)) or any other server, and device(s) 706 may include an electronic device (e.g., device 113 (FIG. 1)), such as a front-end device (e.g., a user device (e.g., mobile phone, tablet, etc.), a desktop computer, or any other suitable electronic device (e.g., including a display)). According to various embodiments, each of server 704 and electronic device(s) 706 may be remote from one or more of mobile units 702. Further, for example, server 704 may include a cloud-based processor.

According to various embodiments of the disclosure, mobile unit 702, which may include a modem, may be within a first location (a “camera location” or a “remote location”), and server 704 may be within a second location, remote from the camera location. In addition, in at least some examples, electronic device 706 may be remote from the camera location and/or server 704. According to various embodiments, mobile unit 702, server 704, and/or electronic device 706 may communicate via one or more metered (e.g., cellular and/or satellite) connections. As will be appreciated by a person having ordinary skill in the art, system 700 may be modular, expandable, and/or scalable.

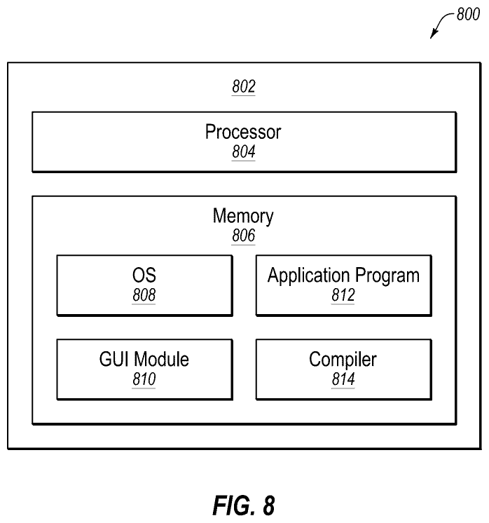

FIG. 8 illustrates a system 800 that may be used to implement embodiments of the disclosure. System 800 may include a computer 802 that comprises a processor 804 and memory 806. In some examples, computer 802 may include computer 206 of FIG. 2A.

For example only, and not by way of limitation, computer 802 may include a workstation, a laptop, or a hand-held device such as a cell phone or a personal digital assistant (PDA), a server (e.g., server 116), computer 110 (see FIG. 1), or any other processor-based device known in the art. In one embodiment, computer 802 may be operably coupled to a display (not shown in FIG. 8), which presents images to the user via a GUI. As will be appreciated, computer 802 may include one or controllers including one or more operating systems, which may be configured and/or updated in accordance with various embodiments disclosed herein.

Generally, computer 802 may operate under control of an operating system 808 stored in memory 806, and interface with a user to accept inputs and commands and to present outputs through a GUI module 810. Although GUI module 810 is depicted as a separate module, the instructions performing the GUI functions may be resident or distributed in the operating system 808, a program 812, or implemented with special purpose memory and processors. Computer 802 may also implement a compiler 814 that allows a program 812 (e.g., code) written in a programming language to be translated into processor 804 readable code. After completion, program 812 may access and manipulate data stored in memory 806 of computer 802 using the relationships and logic that are generated using compiler 814.

Further, operating system 808 and program 812 may include instructions that, when read and executed by computer 802, may cause computer 802 to perform the steps necessary to implement and/or use various embodiments of the disclosure. Program 812 and/or operating instructions may also be tangibly embodied in memory 806 and/or data communications devices, thereby making a computer program product or article of manufacture according to an embodiment of the present disclosure. As such, the term “program” as used herein is intended to encompass a computer program accessible from any computer readable device or media. Program 812 may exist on an electronic device (e.g., electronic device 113; see FIG. 1), a server (e.g., server 116 (FIG. 1), device 504 (FIG. 5)), a unit (e.g., unit 102 (FIG. 1), unit 502 (FIG. 5), mobile unit 602 (FIG. 6), and/or another device. Furthermore, portions of program 812 may be distributed such that some of program 812 may be included on a computer readable media within an electronic device (e.g., electronic device 113), some of program 812 may be included on a computer readable media on a server (e.g., server 116), some of program 812 may be included on a computer readable media on a surveillance unit (e.g., unit 102, unit 402, unit 502, unit 702), and/or some of program 812 may be included on a computer readable media on another device. For example, with reference to FIG. 1, in some embodiments, program 812 may be configured to run on electronic device 113, server 116, unit 102, another computing device, or any combination thereof. As a specific example, program 812 may exist on server 116 and/or unit 102 and may be accessible to a user via electronic device 113.

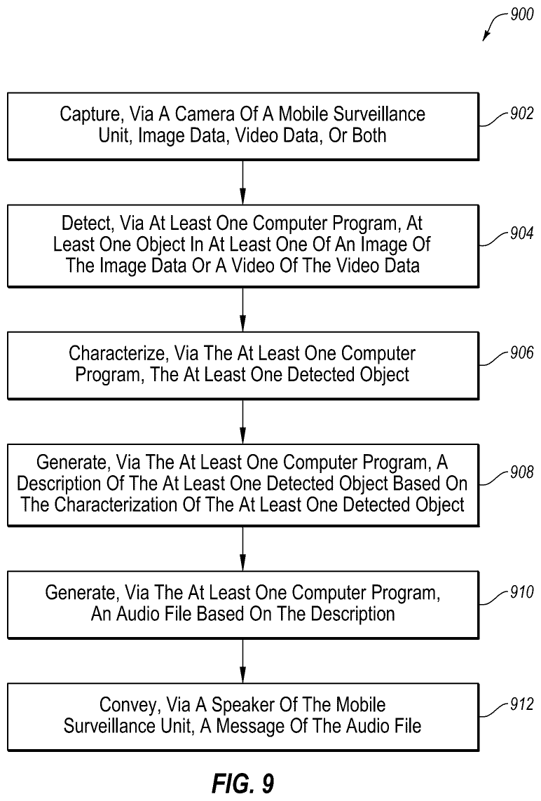

FIG. 9 is a flowchart of an example method 900 of operating a mobile surveillance unit. Method 900 may be arranged in accordance with at least one embodiment described in the disclosure. Method 900 may be performed, in some embodiments, by a device or system, such as system 100 (see FIG. 1), system 200 (see FIG. 2A), system 250 (see FIG. 2B), system 300 (FIG. 3), system 400 (FIG. 4), 500 (FIG. 5), system 600 (see FIG. 6), system 700 (see FIG. 7), system 800 (see FIG. 6), or another device or system. Although illustrated as discrete blocks, various blocks may be divided into additional blocks, combined into fewer blocks, or eliminated, depending on the desired implementation.

Method 900 may begin at block 902, wherein image data, video data, or both, are captured via a camera of a surveillance unit, and method 900 may proceed to block 904. For example, sensors 604 (e.g., cameras) of FIG. 6 of the surveillance unit (e.g., unit 602/702; see FIGS. 6 and 7) may capture the image data, the video data, or both.

At block 904, an object in at least one of an image of the image data and/or a video of the video data is detected via at least one computer program, and method 900 may proceed to block 906. For example, detection device 304 (see FIG. 3), which may include an AI detection model, may detect the object in the image and/or the video. For example, the object may be detected in the image and/or video at the mobile surveillance unit and/or at a cloud device (e.g., cloud server, such as server 704 of FIG. 7).

At block 906, the at least one detected object is characterized via the at least one computer program, and method 900 may proceed to block 908. For example, characterization device 306 (see FIG. 3), which may include an AI characterization model, may identify one or more characteristics of the detected object. In some examples, characterization may be based on the detected object and/or the image and/or the video from which the object is detected. For example, the characterization may be performed at the mobile surveillance unit and/or at a cloud device (e.g., cloud server).

At block 908, a description is generated via the at least one computer program based on the at least one detected object and/or a characterization of the at least one detected object, and method 900 may proceed to block 910. For example, description device 308 (see FIG. 3), which may include an AI description model, may generate a text description based on the at least one detected object, the characteristics (e.g., identified at block 906), the image, the video, or any combination thereof. For example, the text description may be generated at the mobile surveillance unit and/or at a cloud device (e.g., cloud server).

At block 910, an audio file may be generated via the at least one computer program based on the description, and method 900 may proceed to block 912. For example, generation device 310 (see FIG. 3), which may include an AI model (e.g., a text-to-speech AI model), may generate the audio file (e.g., including a voice message) based on the textual description. For example, the audio file may be generated at the mobile surveillance unit and/or at a cloud device (e.g., cloud server).

At block 912, an audio message based on the audio file may be conveyed via a speaker of the mobile surveillance unit. For example, the audio message, which may include a voice message, may be played via an audio device (e.g., including a speaker) of the mobile surveillance unit. More specifically, the speaker may convert an electrical signal to a sound that may be output by the speaker.

Modifications, additions, or omissions may be made to method 900 without departing from the scope of the present disclosure. For example, the operations of method 900 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

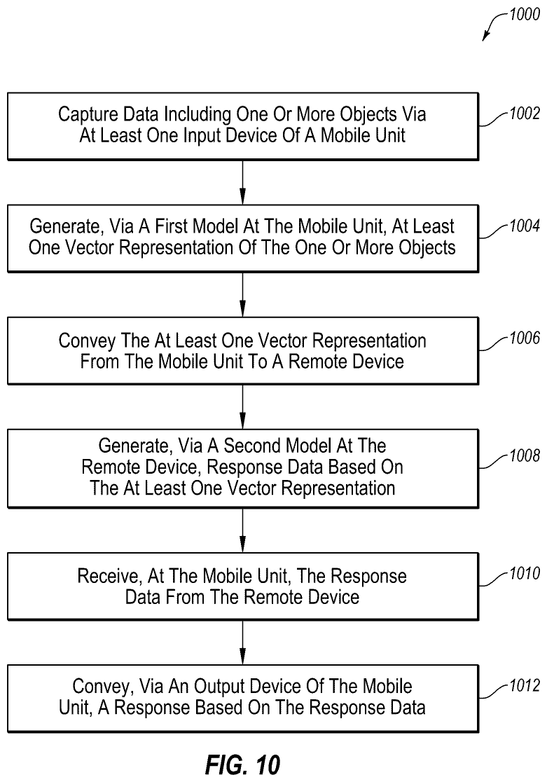

FIG. 10 is a flowchart of an example method 1000 of operating a surveillance system. Method 1000 may be arranged in accordance with at least one embodiment described in the disclosure. Method 1000 may be performed, in some embodiments, by a device or system, such as system 100 (see FIG. 1), system 200 (see FIG. 2A), system 250 (see FIG. 2B), system 300 (see FIG. 3), system 400 (see FIG. 4), system 500 (see FIG. 5), system 600 (see FIG. 6), system 700 (see FIG. 7), system 800 (see FIG. 8), or another device or system. Although illustrated as discrete blocks, various blocks may be divided into additional blocks, combined into fewer blocks, or eliminated, depending on the desired implementation.

Method 1000 may begin at block 1002, wherein data including one or more objects may be captured via at least one input device of a mobile unit, and method 1000 may proceed to block 1004. For example, video data and/or image data including the one or more objects (e.g., a person, a vehicle, etc.) may be captured via camera 506 of unit 502 (see FIG. 5).

At block 1004, at least one vector representation of the one or more objects may be generated, and method 1000 may proceed to block 1006. For example, model 510 (see FIG. 5) may generate at least one vector representation (vector encoding) response to receipt of video data, image data, and/or metadata (e.g., via pipeline 508).

At block 1006, the at least one vector representation may be conveyed from the mobile unit to a remote device, and method 1000 may proceed to block 1008. For example, at least one vector representation, which may be generated via model 510, may be sent from unit 502 to device 504.

At block 1008, response data may be generated based on the at least one vector representation, and method 1000 may proceed to block 1010. For example, the response data may be generated via a model (e.g., model 512 of FIG. 5) at the remote device. As non-limiting examples, the response data may include a text file, an audio file, or any other suitable data.

At block 1010, response data may be received at the mobile unit, and method 1000 may proceed to block 1012. For example, response data, which may be generated by, for example, the remote device (e.g., device 504) responsive to and/or based on the at least one vector representation, may be received at unit 502 (see FIG. 5).

At block 1012, a response that is based on the response data may be conveyed via an output device mobile unit. For example, an audio message (e.g., based on the response data) may be conveyed via a speaker of the mobile unit.

Modifications, additions, or omissions may be made to method 1000 without departing from the scope of the present disclosure. For example, the operations of method 1000 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 1000 may include one or more acts wherein the response data is generated via a generative transformer model (e.g., at a remote device, which may include a server (e.g., a cloud server) remote from the mobile unit).

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system, comprising:
a mobile surveillance unit comprising:
at least one camera to capture at least one of image data or video data;
an audio device including a speaker and to convey contents of an audio file; and
at least one artificial intelligence (AI) model to:
detect one or more objects in at least one of an image or a video captured by the camera;
determine at least one characteristic of the one or more detected objects; and
generate a description based on at least one of the one or more detected objects or the at least one characteristic of the one or more detected objects; and
an additional AI model to generate the audio file based on the description.

2. The system of claim 1, further comprising a server communicatively coupled to the mobile surveillance unit and including the additional AI model.

3. The system of claim 1, wherein the one or more objects comprise a human.

4. The system of claim 3, wherein the at least one characteristic comprises at least one of: a color of an article of clothing worn by the human; an accessory worn or carried by the human; a color of hair of the human; a behavior of the human; a location of the human; or an act performed by the human.

5. The system of claim 4, wherein the contents of the audio file comprise a voice message referencing at least of: the color and the article of clothing; the color of the hair of the human; the behavior of the human; or the act performed by the human.

6. The system of claim 1, wherein the one or more objects comprise a vehicle.

7. The system of claim 6, wherein the at least one characteristic comprises at least one of a color of the vehicle, a type of the vehicle, a make of the vehicle, a model of the vehicle, a license plate number, or a state of the vehicle.

8. The system of claim 7, wherein the contents of the audio file comprise a voice message referencing at least one of: the color of the vehicle; the type of the vehicle; the make of the vehicle, the model of the vehicle, the license plate number; or the state of the vehicle.

9. A system, comprising:
a surveillance unit comprising:
at least one camera for capturing data;
at least one speaker for conveying contents of an audio file; and
at least one computer program to:
detect one or more objects in at least one of an image or a video of the data captured by the camera;
determine at least one characteristic of at least one detected object of the one or more detected objects; and
generate a description based on at least one of the at least one detected object or the at least one characteristic; and
a server remote from and communicatively coupled to the surveillance unit and including at least one additional computer program to generate the audio file based on the description.

10. The system of claim 9, wherein the contents of the audio file include a voice message referencing at least one of the at least one detected object or the at least one characteristic.

11. The system of claim 9, wherein the surveillance unit further comprises:
a trailer;
a mast coupled to the trailer; and
a head unit coupled to the mast and including the at least one camera and the at least one speaker, the head unit further comprising a controller having the at least one computer program stored thereon.

12. The system of claim 9, wherein the at least one characteristic comprises at least one of:
a color of an article of clothing worn by a human;
an accessory worn or carried by the human;
a color of hair of the human;
a behavior of the human;
a location of the human;
an act performed by the human;
a color of a vehicle;
a type of the vehicle;
a make of the vehicle;
a model of the vehicle;
a license plate number of the vehicle; or
a state of the vehicle.

13. A method of operating a surveillance unit, the method comprising:
capturing, via a camera of the surveillance unit, image data, video data, or both;
detecting, via at least one computer program, at least one object in at least one of an image of the image data or a video of the video data;
characterizing, via the at least one computer program, the at least one detected object;
generating, via the at least one computer program, a description of the at least one detected object based on the characterization of the at least one detected object;
generating, via the at least one computer program, an audio file based on the description; and
conveying, via a speaker of the surveillance unit, a message from the audio file.

14. The method of claim 13, wherein generating the audio file comprises generating, via a device remote from the surveillance unit, the audio file.

15. The method of claim 13, wherein:
detecting the at least one object comprises detecting a human;
characterizing the at least one detected object comprises at least one of identifying a color of an article of clothing worn by the human or a behavior of the human; and
conveying the message comprises conveying a voice message referencing at least of the color and the article of clothing or the behavior of the human.

16. The method of claim 13, wherein:
detecting the at least one object comprises detecting a vehicle;
characterizing the at least one detected object comprises at least one of identifying a color of the vehicle, a type of the vehicle, or a state of the vehicle; and
conveying the message comprises conveying a voice message referencing at least one of the color of the vehicle, the type of the vehicle, or the state of the vehicle.

17. The method of claim 13, wherein generating a description comprises generating a text description of the at least one detected object.

18. A system, comprising:
a mobile surveillance unit comprising:
at least one sensor to capture sensor data; and
an output device to generate an output based on an audio file; and
at least one artificial intelligence (AI) model to:
detect one or more objects in the sensor data;
determine at least one characteristic of at least one detected object of the one or more detected objects;
generate a description based on at least one of the at least one detected object or the at least one characteristic; and
generate the audio file based on the description.

19. The system of claim 18, wherein the sensor comprises a camera and the output device comprises an audio device including a speaker.

20. The system of claim 18, wherein the at least one AI model includes:
one or more models to detect the one or more objects in the sensor data, determine the at least one characteristic of the at least one detected object, and generate the description; and
at least one additional model to generate the audio file,
wherein the one or more models are stored on the mobile surveillance unit and the at least one additional model is stored on a server remote from the mobile surveillance unit.
